(19) United States
(12) Patent Application Publication
(10) Pub. No.: US 2006/0110718 A1
(43) Pub. Date: May 25, 2006

(54) System and method for automatically administering a test, analysing test results and formulating study strategies in response thereto

(76) Inventors: Yong T. Lee, Pasadena, CA (US); Hugh Hunter, Santa Monica, CA (US)

Correspondence Address: William J. Benman;Suite 2740, 2049 Century Park East, Los Angeles, CA, 90067, US

(21) Appl. No.: 10/995,694

(22) Filed: Nov. 23, 2004

(51) Int. Cl. G09B 3/00

(52) U.S. Cl. 434/350

(57) ABSTRACT

A mathematically driven system which can be used to diagnose a student's strengths and weaknesses and provide studying strategies based on these strengths and weaknesses. The invention bases studying suggestions not on raw test scores or on simple metrics such as “percent correct”, but on the student's potential to increase their test score by studying a particular topic. The inventive method includes the steps of administering an exam with composite questions relating to a subject and an associated study strategy therefor; analyzing results of said exam to diagnose strengths and weaknesses of a student with respect to said subjects and strategies; and outputting data with respect to optimal strategies for the student with respect to said subjects.

### BACKGROUND OF THE INVENTION

1. Field of the Invention

The present invention relates to computer software and business methods. More specifically, the present invention relates to systems and method for automatically administering exams, analyzing test results and formulating study strategies.

2. Description of the Related Art

Standardized tests are used to assess a test taker's knowledge, ability and/or likelihood of success for a variety of educational, governmental and commercial positions. In the educational arena, a score on an SAT, ACT, or Graduate Records Examination (GRE), and other tests is used as significant component of a college admissions evaluation and selection process. Obviously, one's score on such exams is of paramount importance. For this reason, a number of preparatory courses are currently on the market. Such courses include Kaplan SAT Online, the Princeton Review and Peterson's Test Prep by way of example. These courses generally feature online distribution of course material and administration of practice exams and provide raw test scores or simple metrics such as percent correct. However, raw test scores and simple metrics do not provide the student with much guidance as to how to improve the test score.

Hence, a system or method is needed for administering a test, analyzing test results, diagnosing a student's strengths and weaknesses and suggesting studying strategies based on the diagnosis.

### SUMMARY OF THE INVENTION

The present invention sets out to address the need in the art in the field of test preparation with a focus specifically on but not limited to standardized, admissions testing. The present invention provides a mathematically driven system which can be used to diagnose a student's strengths and weaknesses and provide studying strategies based on these strengths and weaknesses. The present invention bases studying suggestions not on raw test scores or on simple metrics such as “percent correct”, but on the student's potential to increase their test score by studying a particular topic.

The inventive method includes the steps of administering an exam with composite questions relating to a subject and an associated study strategy therefor; analyzing results of said exam to diagnose strengths and weaknesses of a student with respect to said subjects and strategies; and outputting data with respect to optimal strategies for the student with respect to said subjects.

In the best mode, the step of diagnosing strength and weaknesses includes the step of computing an AspenRank. The step of computing the AspenRank includes the steps of: 1) computing as a raw score the number of questions answered correctly divided by the number of questions posed in said exam; 2) computing a weighted score equal to the raw score times a weight, the weight being based on a difficulty of said questions posed; and 3) computing a weighted incorrect score equal to a number of questions answered incorrectly times a weight, the weight being again based on the difficulty of said questions posed. The step of computing the AspenRank includes the step of ascertaining a student's strength in an area based on all of the above factors plus the overall frequency of a certain type of question on a given test. AspenRank score is a measure of potential yield in said scores if a student studies a subject or strategy area.

The invention is disclosed herein with respect to the SAT, but the present teachings are not limited thereto.

### BRIEF DESCRIPTION OF THE DRAWINGS

FIG. 1 is a diagram of a typical client-server architecture for use in connection with the present teachings.

FIG. 2 is a flow diagram illustrative of the method of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention operates on the assumption that a student can increase his or her test score in two ways:
By increasing his understanding of specific subjects covered by the test.
By increasing his awareness of specific test-taking strategies that can either
   Help the student eliminate incorrect answers
   Help the student identify correct answers
   Decrease the amount of time that it takes to identify correct answers

Test questions can therefore be described in terms of one or more subjects and one or more strategies that apply to that specific question. A student's performance on an individual question then essentially “casts a vote” for his familiarity with the underlying subjects and strategies assigned to that question.

If the student gets a question right, this is evidence that he understands the underlying subjects and strategies assigned to that question. If the student gets a question wrong, this is evidence that he does not understand these subjects and strategies. This information, once aggregated, suggests a student's strengths and weaknesses in particular subject areas and with particular test-taking strategies.

The present invention, then, takes this information into consideration along with some additional factors to suggest to the student, on a subject-by-subject or strategy-by-strategy basis, which subjects or strategies the student should study to get the highest yield in the form of higher test scores on future tests.

In accordance with the present teachings, an AspenRank score is calculated for each subject that is tested within a given test and for each strategy that applies to a given test.

The AspenRank score for a specific subject or strategy takes into Consideration the following:
RAW_SCORE=number of correct/number of questions posed
WEIGHTED_CORRECT_SCORE=weighted number of correct answers/number of questions posed with correct answers weighted based on the difficulty of the question (1-5, 5 being the most difficult)
WEIGHTED_INCORRECT_SCORE=weighted number of incorrect answers/number of questions posed with incorrect answers weighted based on the difficulty of the question (−1 to −5, −5 being assigned to getting an easy question wrong and −1 assigned when getting a difficult question wrong)
UNANSWERED=number of questions left unanswered
TOTAL_POSED=number of questions on the test for a given subject or strategy

To clarify, for WEIGHTED_CORRECT_SCORE and WEIGHTED_INCORRECT_SCORE, the following table is used:

| | Difficulty | Correct | Incorrect |
|---|---|---|---|
| Easiest | 1 | +1 | −5 |
| | 2 | +2 | −4 |
| | 3 | +3 | −3 |
| | 4 | +4 | −2 |
| Hardest | 5 | +5 | −1 |

Thus, the student is rewarded more for getting hard questions correct and penalized more for getting easy question wrong. These two pieces of information taken together most realistically describe a student's strength in an area.

Consider the following example:

A student gets 5 questions correct out of 10 posed. A grade of 50%

Now suppose the difficulties of these questions were: 1, 1, 2, 2, 3, 3, 4, 4, 5, 5

Now suppose there is Student A and Student B, both of whom scored 5/10. But their correct answers are indicated by bold (no questions left unanswered):

| | Student A | Student B |
|---|---|---|
| | 1, 1, 2, 2, 3, 3, 4, 4, 5, 5 | 1, 1, 2, 2, 3, 3, 4, 4, 5, 5 |
| Un-weighted score: | 5/10 = 50% | 5/10 = 50% |
| Weighted correct: | 9/30 = 30% | 21/30 = 70% |
| Weighted incorrect: | 21 − 9/−3 = 370% | −921/−30 = 730% |

Student B has a much better understanding of the subject matter, as evidenced by getting harder questions correct. Student B also has higher potential to improve his score because he merely needs to answer a few simple questions correctly to improve his score whereas Student A may have a more fundamental lack of understanding on his hands.

In the example above, the WEIGHTED_CORRECT and WEIGHTED_INCORRECT are equal, but this is not always the case because a) difficulty distributions are not always even, as they were in the example and b) often a student will leave a question unanswered, which is does not mean it was incorrect per se.

In accordance with the present teachings, other factors are taken into consideration such as how often a specific subject or strategy appears on a test (TOTAL_POSED) and how many questions were left unanswered (UNANSWERED). UNANSWERED is relevant because, on many tests, unanswered questions are actually preferable to incorrectly answered questions because there is a penalty for wrong answers. Therefore, a strategy to improve one's score is often to stop getting answers wrong as opposed to getting more right or, in most cases, to stop guessing altogether.

TOTAL_POSED is highly important to the present invention because it suggests the amount of potential yield a student could get by studying a particular area based on how often that subject is actually on the test.

Consider this:

Two students, Student A and Student B, get identical scores on a particular subject. Correct answers again indicated by bold.

| | Student A | Student B |
|---|---|---|
| Questions | 1, 5 | 1, 1, 1, 1, 5, 5, 5, 5 |
| Un-weighted Score | ½ = 50% | 4/8 = 50% |
| Weighted Correct Score | 5/6 = 83% | 20/24 = 83% |
| Weighted Incorrect Score | −51/−6 = 1783% | −204/−24 = 1783% |

Even though these two students have identical weighted correct and weighted incorrect scores, the TOTAL POSED factor would ensure that Student B would have a higher AspenRank for this subject area because there are more questions that he can pick up by studying that subject area. There is not as much yield to be had by Student A since, at best, he could only pick up one additional question correct.

AspenRank in Practice

All of the factors described above are weighted and averaged to come up with an AspenRank that ranges from 0 to 5 in increments of 0.5. An AspenRank of 5 indicates high potential yield if the student studies that subject or strategy area. An AspenRank of 0 indicates low to no potential yield if the student studies that subject or strategy area.

Based on the discussion above, the following is true:

An AspenRank of zero can be achieved in two ways:
1. If the student gets 100% of the questions right there is no score improvement to be had by studying that subject, thus no potential yield and an AspenRank of zero.
2. If the student gets 0% of the questions right there is no indication that the student has any understanding of the subject or strategy area, thus the problem is more structural and not easily remedied by a “brush up” tutorial on the topic.

An AspenRank of five is achieved when a student gets some questions right, some wrong, and when those he got right outweigh those he got wrong when the difficulties of the questions are taken into consideration. Also, a subject or strategy area with an AspenRank of five likely means that there are a fair amount of questions on the test that cover that specific subject or strategy area.

The loftier the score improvement that the student wants to achieve, the lower in the AspenRanking scores the student will focus when studying. Inversely, if only a minor improvement is wanted, a student need only study the subjects and strategies with the highest AspenRank.

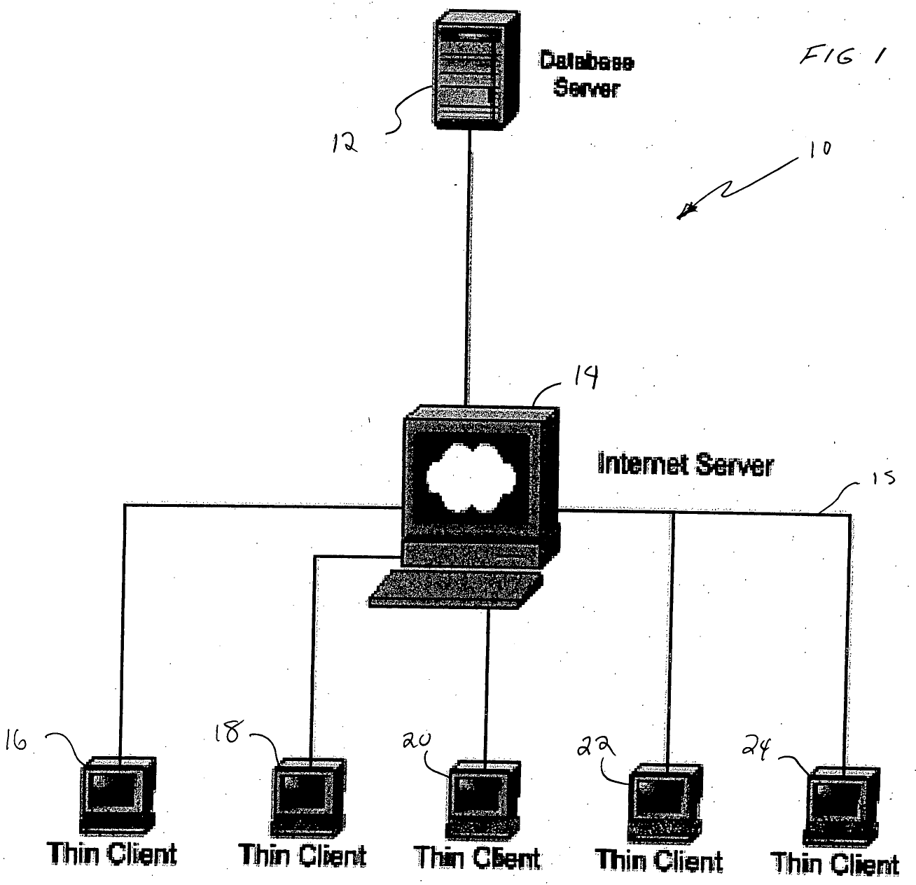

FIG. 1 is a diagram of a typical client-server architecture for use in connection with the present teachings. The architecture 10 includes a database server which executes the software 100 of the present invention. In the illustrative architecture, the database server 12 feeds an Internet server 14. The server communicates with users via a network 15 and numerous client computers of which five are shown 16, 18, 20, 22 and 24. Those skilled in the art will appreciate that the network 15 may be the Internet, a local area network or another network without departing from the scope of the present teachings.

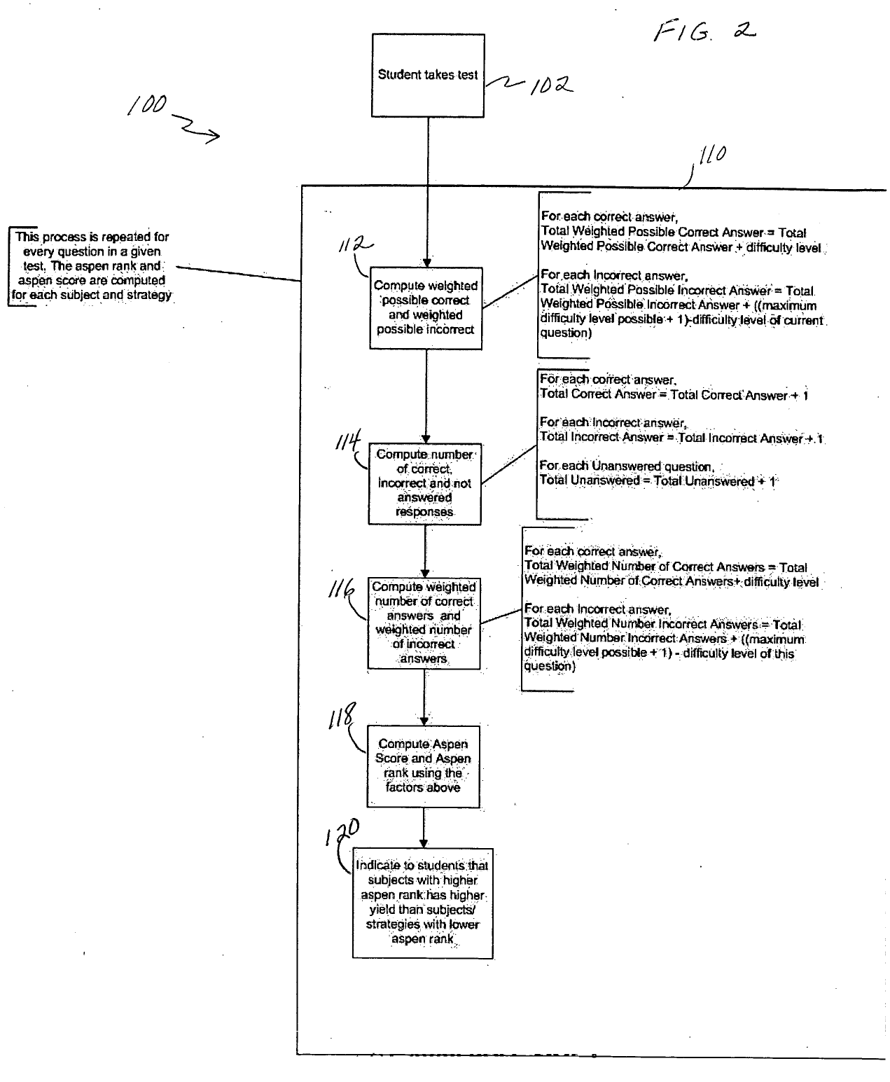

FIG. 2 is a flow diagram illustrative of the method of the present invention. In the best mode, the process illustrated in FIG. 2 is implemented in software 100. At step 102, a test is administered. At step 110, the test data is analyzed in accordance with the present teachings. As a first step in the analysis of the data, weighted possibly correct and incorrect scores are computed at step 112. For each correct answer, the total weighted possible correct answers are computed as being equal to the total possible correct answers, each multiplied (weighted) by a plus a measure of the level of difficulty of the question. Likewise for each incorrect answer, the total weighted possible incorrect answer is computed as being equal to the sum of the weight of the incorrect answers for all the questions posed, the weight being computed based on the difficulty level of the question (−1 being assigned to getting a difficult question wrong and −5 being assigned to getting an easy question wrong).

At step 114, the number of correct, incorrect and not answered responses is computed. In other words, the total number of correct, incorrect and unanswered questions is incremented. We increment the totals at step 114 to obtain the raw number of correct, incorrect and unanswered questions from the student responses.

Next, at step 116 the weighted number of correct and incorrect answers is computed. For each correct answer, the total weighted number of correct answers is equal to the total weighted number of correct answers plus the level of difficulty of the question. For each incorrect answer, the total weighted number of incorrect answers is computed as the sum of the weight of the incorrect answers for the questions with incorrect answer, the weight being computed based on the difficulty level of the question (−1 being assigned to getting a difficult question wrong and −5 being assigned to getting an easy question wrong).

Finally, at step 118, the Aspen score and the Aspen rank are computed in accordance with the present teachings using the factors determined above and at step 120, data is output to the student which indicates which subjects and strategies have higher Aspen rank and yield relative to subjects and strategies with lower Aspen rank and yield.

Thus, the present invention has been described herein with reference to a particular embodiment for a particular application. Those having ordinary skill in the art and access to the present teachings will recognize additional modifications applications and embodiments within the scope thereof.

It is therefore intended by the appended claims to cover any and all such applications, modifications and embodiments within the scope of the present invention.

Accordingly,

What is claimed is:

1. A method including the steps of:
administering an exam with composite questions relating to a subject and an associated study strategy therefor;
analyzing results of said exam to diagnose strengths and weaknesses of a student with respect to said subjects and strategies; and
outputting data with respect to optimal strategies for the student with respect to said subjects.

2. The invention of claim 1 wherein the step of diagnosing strength and weaknesses includes the step of computing an AspenRank.

3. The invention of claim 2 wherein the step of computing the AspenRank includes the step of computing as a raw score the number of questions answered correctly divided by the number of questions posed in said exam.

4. The invention of claim 3 wherein the step of computing the AspenRank further includes the step of computing a weighted score equal to the raw score times a weight.

5. The invention of claim 4 wherein said weight is based on a difficulty of said questions posed.

6. The invention of claim 5 wherein the step of computing the AspenRank further includes the step of computing a weighted incorrect score equal to a number of questions answered incorrectly on said exam divided by the number of questions posed times said weight.

7. The invention of claim 6 wherein the step of computing the AspenRank further includes the step of ascertaining a student's strength in an area based on at least one of said student's weighted scores.

8. The invention of claim 7 wherein said strength is measured by an AspenRank score.

9. The invention of claim 8 wherein said AspenRank score is a measure of potential yield in said scores if a student studies a subject or strategy area.

10. A system comprising:
means for administering an exam with composite questions relating to a subject and an associated study strategy therefor;
means for analyzing results of said exam to diagnose strengths and weaknesses of a student with respect to said subjects and strategies; and
means for outputting data with respect to optimal strategies for the student with respect to said subjects.

11. The invention of claim 10 wherein the means for diagnosing strength and weaknesses includes means for computing an AspenRank.

12. The invention of claim 11 wherein the means for computing the AspenRank includes means for computing as a raw score the number of questions answered correctly divided by the number of questions posed in said exam.

13. The invention of claim 12 wherein the means for computing the AspenRank further includes means for computing a weighted score equal to the raw score times a weight.

14. The invention of claim 13 wherein said weight is based on a difficulty of said questions posed.

15. The invention of claim 14 wherein the means for computing the AspenRank further includes means for computing a weighted incorrect score equal to a number of questions answered incorrectly on said exam divided by the number of questions posed times said weight.

16. The invention of claim 15 wherein the means for computing the AspenRank further includes means for ascertaining a student's strength in an area based on at least one of said student's weighted scores.

17. The invention of claim 16 wherein said strength is measured by an AspenRank score.

18. The invention of claim 17 wherein said AspenRank score is a measure of potential yield in said scores if a student studies a subject or strategy area.

19. A system for administering an exam and providing a recommended study strategy based on results thereof comprising:
a network;
a server coupled to said network;
software running on said server for administering an exam via said network and providing a recommended study strategy based on results thereof, said software including code for:
administering an exam with composite questions relating to a subject and an associated study strategy therefor;
analyzing results of said exam to diagnose strengths and weaknesses of a student with respect to said subjects and strategies; and
outputting data with respect to optimal strategies for the student with respect to said subjects; and
a mechanism for accessing said server via said network and thereby interface with said software.

20. The invention of claim 19 wherein said network is the Internet.

21. The invention of claim 19 wherein said mechanism is a computer.

22. The invention of claim 21 wherein said mechanism is configured as a client computer.
